(19) United States
(12) Patent Application Publication
(10) Pub. No.: US 2004/0230317 A1
(43) Pub. Date: Nov. 18, 2004

(54) Method, system, and program for allocating storage resources

(75) Inventors: Subramanya Kumar, Louisville, CO (US); Brandon E. Taylor, Longmont, CO (US)

Correspondence Address: B. NOEL KIVLIN, MEYERTONS, HOOD, KIVLIN, KOWERT & GOETZEL, P.C., P.O. BOX 398, AUSTIN, TX, 78767-0398, US

(73) Assignee: Sun Microsystems, Inc.

(21) Appl. No.: 10/440,218

(22) Filed: May 15, 2003

(51) Int. Cl. G05B 15/00

(52) U.S. Cl. 700/1

(57) ABSTRACT

Provided are a method, system, and program for allocating resources, wherein the resources are capable of being configured from a computer system. User interface elements are rendered enabling user selection of a plurality of strategies concerning allocation of computational resources, including a participation strategy having one of at least two values indicating a degree of user involvement in the allocation of computational resources and at least one configuration strategy specifying a configuration for the resource allocation. Selection of a plurality of resource allocation constraints is enabled if the selected value for the participation strategy is a first value. Selection of one of a plurality of configuration modes is enabled if the selected value for the participation strategy is a second value. An allocation is made of the resources based on the selected at least one configuration strategy and one of the selected resource allocation constraints or the selected configuration mode.

### BACKGROUND OF THE INVENTION

1. Field of the Invention

The present invention relates to a method, system, and program for allocating resources capable of being configured from a computer system.

2. Description of the Related Art

A storage area network (SAN) comprises a network linking one or more servers to one or more storage systems. Each storage system could comprise a Redundant Array of Independent Disks (RAID) array, tape backup, tape library, CD-ROM library, or JBOD (Just a Bunch of Disks) components. Storage area networks (SAN) typically use the Fibre Channel protocol, which uses optical fibers to connect devices and provide high bandwidth communication between the devices. In Fibre Channel terms the one or more switches interconnecting the devices are called a “fabric”. However, SANs may also be implemented in alternative protocols, such as InfiniBand**, IPStorage over Gigabit Ethernet, etc.

In the current art, to add or modify the allocation of storage or other resources in a SAN, an administrator must separately utilize different software programs to configure the SAN resources to reflect the modification to the storage allocation. Not only does the administrator have to separately invoke one or more configuration tools to implement the requested storage allocation change throughout the SAN, but the administrator may also have to perform these configuration operations repeatedly if the configuration of multiple distributed devices is involved. For instance, to add several gigabytes of storage to a host logical volume, the administrator may allocate storage space on different storage subsystems in the SAN, such as different RAID boxes. In such case, the administrator would have to separately invoke the configuration tool for each separate device involved in the new allocation. Further, when allocating more storage space to a host logical volume, the administrator may have to allocate additional storage paths through separate switches that lead to the one or more storage subsystems including the new allocated space. The complexity of the configuration operations the administrator must perform further increases as the number of managed components in a SAN increase. Moreover, the larger the SAN, the increased likelihood of applications and users requesting storage space reallocations to reflect new storage allocation needs. The above described difficulties in configuring resources in a Fibre Channel SAN environment are also experienced in other storage environments including multiple storage devices, hosts, and switches, such as InfiniBand**, IPStorage over Gigabit Ethernet, etc.

Not only is the configuration process complicated, but many network administrators lack sufficient knowledge to optimally select options for configuration.

### SUMMARY OF THE DESCRIBED IMPLEMENTATIONS

Provided are a method, system, and program for allocating resources, wherein the resources are capable of being configured from a computer system. User interface elements are rendered enabling user selection of a plurality of strategies concerning allocation of computational resources, including a participation strategy having one of at least two values indicating a degree of user involvement in the allocation of computational resources and at least one configuration strategy specifying a configuration for the resource allocation. Selection of a plurality of resource allocation constraints is enabled if the selected value for the participation strategy is a first value. Selection of one of a plurality of configuration modes is enabled if the selected value for the participation strategy is a second value. An allocation is made of the resources based on the selected at least one configuration strategy and one of the selected resource allocation constraints or the selected configuration mode.

In further implementations, the selected participation strategy values include a ust-in-time strategy and a just-in-case allocation strategy.

Still further, the selected resource allocation constraints include constraints concerning performance and availability. In such case, the computational resource to be allocated comprise network storage resources, the selected performance constraints indicate read and write operation performance parameters for the network storage resources to allocate, and the availability constraints indicate path redundancy and data redundancy for the network storage resources to allocate.

In yet further implementations, a determination is made of a plurality of resource options, wherein each resource option indicates a different set of computational resources available for allocation that satisfy the selected resource allocation constraints and the selected configuration strategy. A selectable list of the determined resource options, is rendered, wherein the step of allocating computational resources performs the allocation and configuration with respect to the computational resources indicated in a selected resource option from the selectable list.

### BRIEF DESCRIPTION OF THE DRAWINGS

Referring now to the drawings in which like reference numbers represent corresponding parts throughout:

FIG. 1 illustrates a network computing environment in which components of the invention are implemented;

FIG. 2 illustrates a representation of storage allocation strategies in accordance with implementations of his invention;

FIG. 3 illustrates an administrator system in accordance with implementations of the invention;

FIGS. 4, 5, and 6 illustrate graphical user interface (GUI) elements used to enable a system administrator to select storage strategies for a storage allocation in accordance with implementations of the invention;

FIGS. 7 and 8 illustrate logic to implement an administrator selected storage strategy in accordance with implementations of the invention; and

FIG. 9 illustrates an architecture of computing devices that may be used with the described implementations.

### DETAILED DESCRIPTION OF THE EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

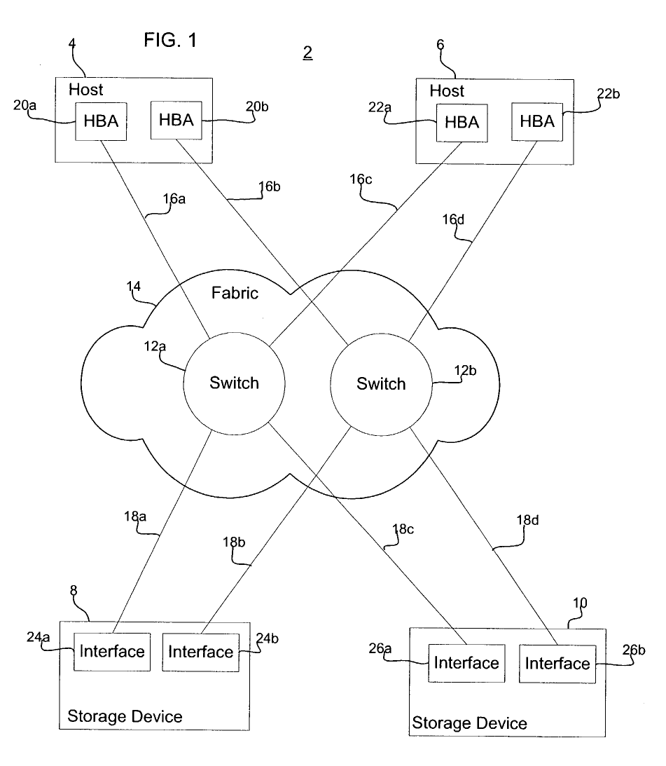

FIG. 1 illustrates an implementation of a computer network, such as a Fibre Channel based storage area network (SAN) which may be configured using the implementations described herein. Host computers 4 and 6 may comprise any computer system that is capable of submitting an Input/Output (I/O) request, such as a workstation, desktop computer, server, mainframe, laptop computer, handheld computer, telephony device, etc. The host computers 4 and 6 would submit I/O requests to storage devices 8 and 10. The storage devices 8 and 10 may comprise any storage device known in the art, such as a JBOD (just a bunch of disks), a RAID array, tape library, storage subsystem, etc. Switches 12a, 12b interconnect the attached devices 4, 6, 8, and 10. The fabric 14 comprises the switches 12a, b that enable the interconnection of the devices. In the described implementations, the links 16a, 16b, 16c, 16d and 18a, 18b, 18c, 18d connecting the devices may comprise Fibre Channel fabrics, Internet Protocol (IP) switches, Infiniband fabrics, or other hardware that implements network communication protocols, such as Fibre Channel Arbitrated Loop (FCAL), IP, Infiniband, etc. In alternative implementations, the different components of the system may comprise any network communication technology known in the art. Each device 4, 6, 8, and 10 includes multiple network interfaces 20a, 20b, 22a, 22b, 24a, 24b, 26a, and 26b, where each interface, also referred to as a device or host bus adaptor (HBA), can have one or more ports. Moreover, the network arrangement may include additional storage devices, hosts, host bus adaptors, switches, etc., than those illustrated in FIG. 1.

A “path”, as that term is used herein, refers to all the components providing a connection from a host to a storage device. For instance, a path may comprise host adaptor 20a, fiber 16a, switch 12a, fiber 18a, and device interface 24a, and the storage devices or disks being accessed. Any component within the path comprises a network storage resource.

In deciding on a configuration for a storage space to allocate to an application and/or user, the system administrator must balance certain tradeoffs and decide on different configuration arrangements. One such tradeoff is the space and time tradeoff, which may involve selecting ajust-in-time or ajust-in-case configuration policy. In a just-in-case strategy, the storage administrator decides to expend time to configure and optimize storage resources in advance of an anticipated need for such resources. A just-in-case strategy may be adopted when the system administrator is familiar with the application workload as well as the capabilities of the available network storage resources to configure. In such cases, the system administrator may spend time to configure and initialize network storage to meet the future needs of the applications and users. In a just-in-time strategy, the storage administrator elects to conserve time and delay configuring storage resources to meet storage needs until the time that the resources are needed by the application. This strategy is often adopted when the storage administrator does not possess suitable knowledge on how to configure storage resources and the capabilities of the application workload and network storage resources. For a just-in-time strategy, the management system or software will configure network storage resources for the application at or near the time when storage resources are needed.

The system administrator may also select a composition strategy for the storage resources. There are three possible composition strategies:

(1) Exact Match Composition: This composition strategy identifies one storage device that is capable of satisfying the storage demands of the application. This strategy avoids the need to make any composition decisions.

(2) Aggregate Composition: This composition strategy identifies available storage areas on multiple storage devices and aggregates the distributed storage areas to form a single storage space capable of satisfying the storage needs of the applications.

(3) Breakup Composition: This composition strategy partitions the storage area of a single storage device into a partition to allocate to satisfy the application storage needs.

The system administrator may also decide a span or scope strategy, which involves the system administrator determining whether the storage devices available to provide the allocated storage space comprise homogeneous devices, i.e., of the same type and/or from the same manufacture, or heterogeneous devices, of different types and/or from different manufacturers. For instance, heterogeneous devices may comprise storage devices configured with different RAID ranks, a RAID configured device and non-RAID device, or devices with the same configuration from different manufactures.

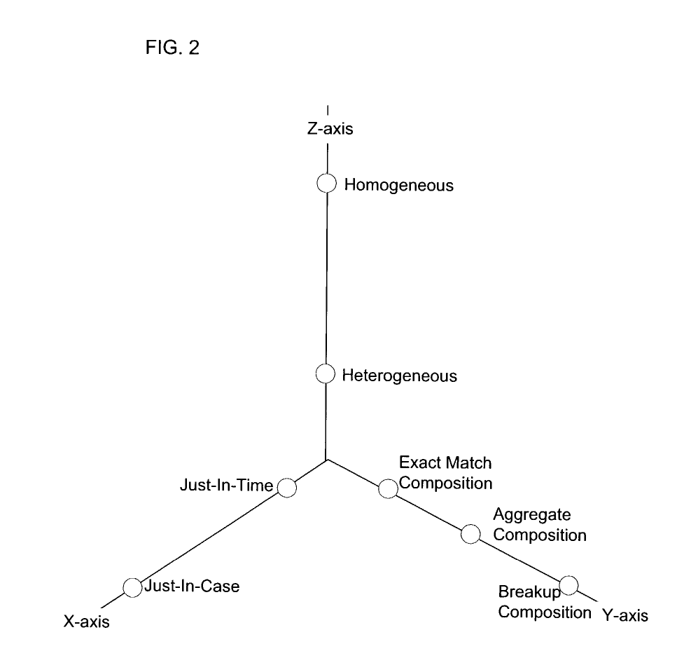

FIG. 2 illustrates a conceptualization of the different provisioning strategies in a three dimensional space. The space/time selections (just-in-time and just-in-case) are represented as points on the x-axis; the composition strategy selections (exact match composition, aggregate composition, and breakup composition) are represented as points on the y-axis; and the span/scope selections (heterogenous and homogenous) are represented as points on the z-axis. The system administrator may select an overall allocation strategy that is represented as a point in the three dimensional space of FIG. 2 whose (x, y, z) coordinates reflect the selected component strategies (space/time, composition, and span/scope) that together comprise the overall strategy. A coordinate for a component strategy may also have zero value indicating that the system administrator has not selected a specific provisioning strategy. The configuration would be based on the coordinate values representing the specific selected provisioning strategies.

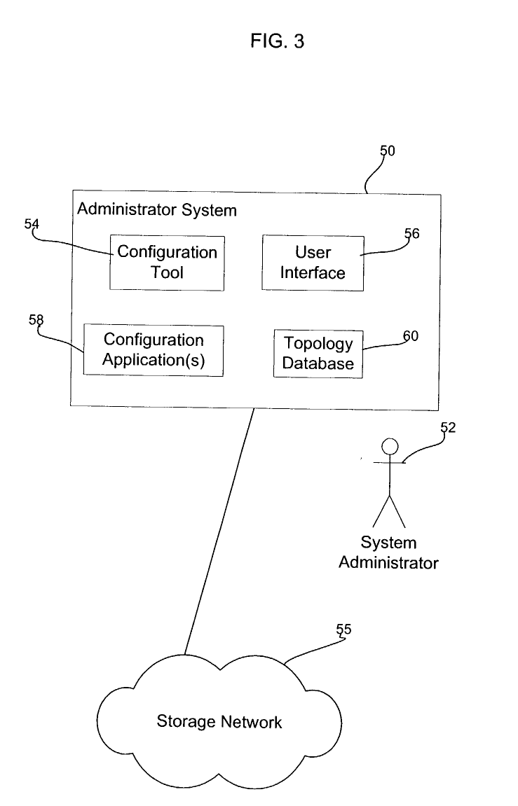

FIG. 3 illustrates an administrator system 50 used by a system administrator 52 to allocate storage resources to application programs and users in the storage network 55, which may comprise the storage network shown in FIG. 1. The system administrator system 50 may connect directly to a network switch or connect to the network through a host system 4, 6 or other device (FIG. 1). The administrator system 50 includes a configuration tool 54 program that is executed to perform configuration operations described herein and a user interface 56 generated by the configuration tool 54 to enable the system administrator 52 to select configuration strategies that the configuration tool 54 would implement. The configuration tool 54 would call one or more configuration applications 58 to configure specific network components, such as switches and storage devices, to allocate storage resources and associated paths to an application or user. The one or more configuration applications 58 may be separate standalone programs called by the configuration tool 54 or routines within the configuration tool 54. The configuration applications 58 may include code to enable configuration of one or more devices (e.g., switches, storage devices, interface cards, etc.) within the network 55. Additionally, the configuration applications 58 may comprise a device and network management model, such as the Common Information Model (CIM)/Web Based Enterprise Management (WEBM) network device management model promulgated by the Distributed Management Task Force (DMTF).

A topology database 60 provides information on the topology of all the resources in the system, i.e., the connections between the host bus adaptors, switches and storage devices. The topology database 60 may be created during system initialization and updated whenever changes are made to the SAN network configuration in a manner known in the art. For instance, the Fibre Channel and SCSI protocols provide protocols for discovering all of the components or nodes in the system and their connections to other components. Alternatively, out-of-band discovery techniques could utilize Simple Network Management Protocol (SNMP) commands to discover all the devices and their topology. The result of the discovery process is the topology database 60 that includes entries identifying the resources in each path in the system. Any particular resource may be available in multiple paths. For instance, a switch may be in multiple entries as the switch may provide multiple paths between different host bus adaptors and storage devices. The topology database 60 can be used to determine whether particular devices, e.g., host bus adaptors, switches and storage devices, can be used, i.e., are actually interconnected, and available. The copending and commonly assigned United States patent application entitled “Method, System, and Program for Discovering Components Within a Network”, having U.S. patent application Ser. No. 10/209,544 and filed on Jul. 31, 2002, which patent application is incorporated herein by reference in its entirety, describes a technique for discovering components and their interconnection in a network, and may be used to discover the components identified in the topology database 60.

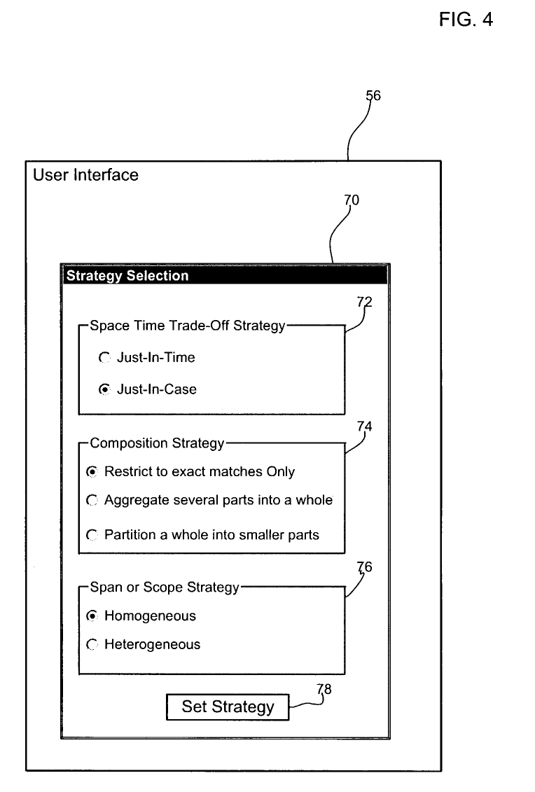

FIGS. 4, 5, and 6 illustrate graphical user interface (GUI) panels that may be rendered in one or more windows within the user interface 56 to enable the system administrator 52 to select configuration settings that the configuration tool 54 would use to configure storage devices and paths to allocate to an application or user. FIG. 4 illustrates a strategy selection window 70 in which the system administrator 52 may select component strategies for an overall allocation strategy, where each such component strategy may comprise a point in the allocation strategy space illustrated in FIG. 2. A space time trade-off strategy panel 72 enables the system administrator 52 to select between a just-in-case or just-in-time strategy; a composition strategy panel 74 enables the system administrator 52 to select a composition strategy (exact match, aggregate or breakup composition strategy); and a span or scope strategy panel 76 enables the system administrator 52 to select a span or scope strategy (heterogeneous or homogeneous). The system administrator 52 would select the set strategy button 78 to finalize the selected overall allocation strategy for use by the configuration tool 54 when configuring and allocating storage. In the illustrated example of FIG. 4, selection of the strategies is made by selecting a radio button corresponding to the desired strategy component of the overall allocation strategy. However, alternative user interface elements known in the art may be used to allow selection of the component strategy values, such as drop down lists, check boxes, etc.

In certain implementations, if the system administrator 52 selects ajust-in-case strategy in the space time tradeoff panel 72, then the configuration tool 54 may render a quantitative storage constraints window 90 in the user interface 56 to enable the system administrator 52 to select specific parameters for use when configuring and allocation storage space. As discussed, the just-in-case strategy presumes the system administrator 52 has sufficient knowledge of application workload and configuration options to determine selection of more detailed configuration operations and constraints. A performance constraints panel 92 enables the system administrator 52 to select specific ranges of values based on the anticipated application or user usage of the allocated storage resource, such as the number of read operations per second, the number of write operations per second, the number of megabytes (MB) read per second, the number of megabytes written per second, the data access pattern (i.e., sequential or random access), etc. The system administrator 52 may select none or any number of the performance constraints in the panel 92 for which to provide values. A capacity constraints panel 94 enables the system administrator 52 to specify the capacity of the storage resource to allocate and the availability constraints panel 96 enables the system administrator 52 to select factors that affect availability, redundancy, and reliability, such as the number of alternate paths to the storage devices configured for the storage allocation and the RAID level.

Upon entering values for the different storage constraints in panels 92, 94, and 96, the system administrator 52 may select the evaluate button 98 to cause the configuration tool 54 to determine different storage options, where each option comprises a set of storage devices and paths in the network capable of being configured and allocated to satisfy the selected storage constraints. The configuration tool 54 would then display the results of such evaluation in an evaluation results panel 100, where each result provides information on a different storage option. With each determined storage option, the configuration tool 54 would indicate the extent to which the option would satisfy the system administrator 52 selected storage constraints and a cost of the possible storage option, which may be expressed as a monetary value or other cost unit descriptor. The system administrator 52 may select one of the possible storage options listed in the evaluation results panel 100 and then the enforce button 102 to cause the configuration tool 52 to implement the selected configuration and allocate storage space using the selected storage option, including storage and other network storage resources (host adaptors, switches, etc).

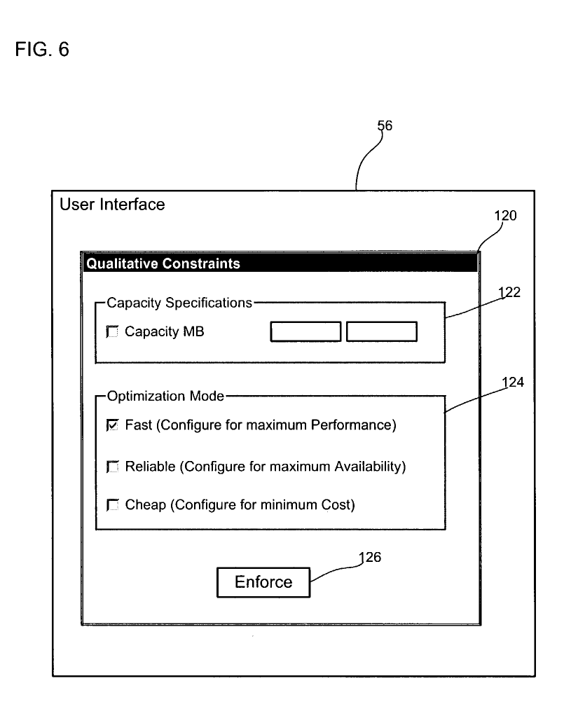

In certain implementations, if the system administrator 52 selects a just-in-time strategy in the space time tradeoff panel 72, the configuration tool 54 may display in the user interface 56 a qualitative constraints window 120 shown in FIG. 6 to enable the system administrator 52 to select general configuration goals for the configuration tool 54 to use when configuring and allocating storage space. As discussed, the just-in-time strategy presumes the system administrator 52 lacks knowledge of configuration options and is satisfied with limited involvement in the configuration process. The qualitative constraint window 120 enables the system administrator 52 to select general parameters for configuration, which the configuration tool 54 would then map to specific constraints to use with the configuration. The qualitative constraints window 90 renders a capacity specification panel 122 in which the system administrator 52 may specify an amount of storage space to configure for the allocation and an optimization mode panel 124 in which the system administrator 52 may select a general configuration goal. The configuration tool 54 would implement specific configuration parameters and constraints defined for the selected general configuration goal, such as Fast, Reliable or Cheap. Upon selecting the general configuration options, the system administrator 52 may then select the enforce button 126 to cause the configuration tool 54 to implement the configuration and allocation of storage space according to the configuration options selected in the strategy selection 70 and qualitative constraints 120 windows.

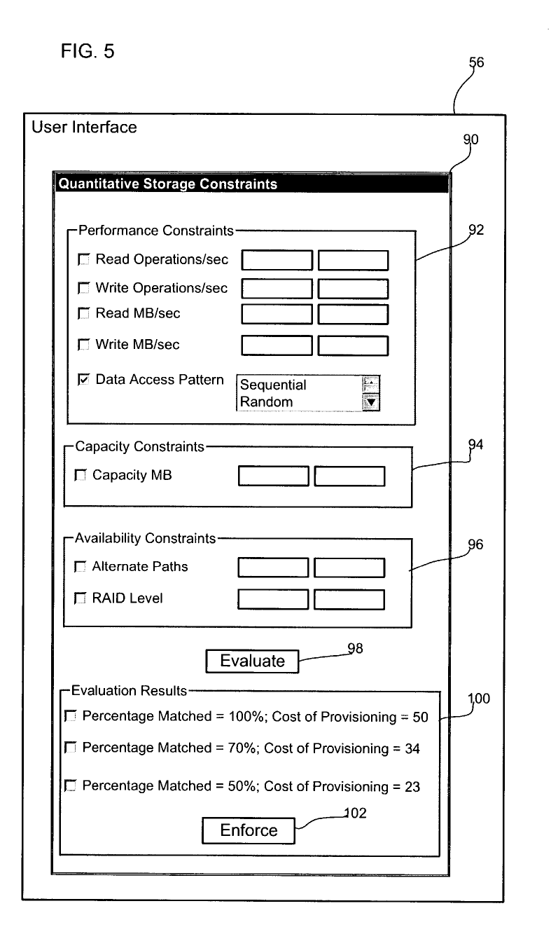

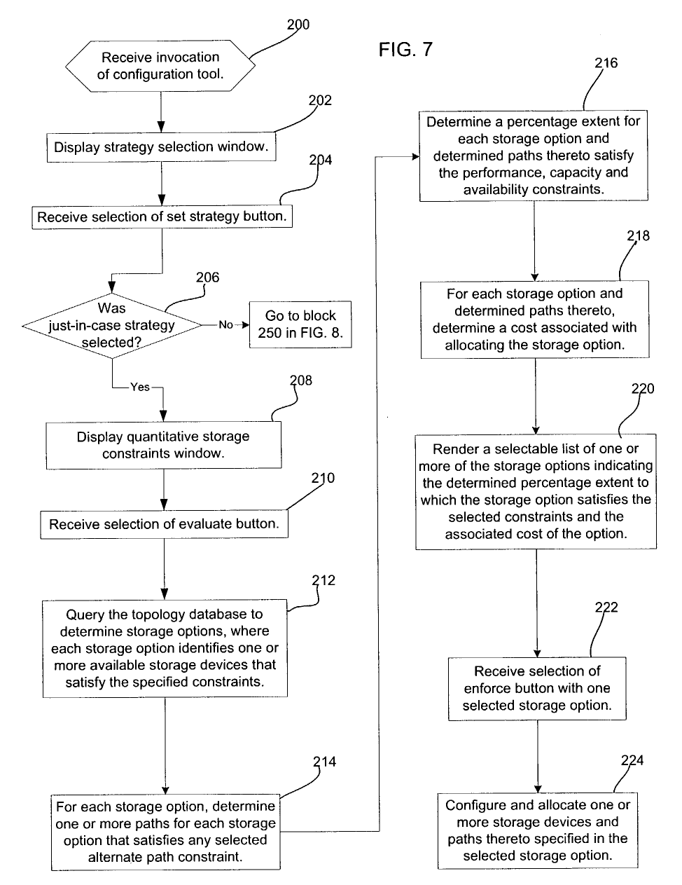

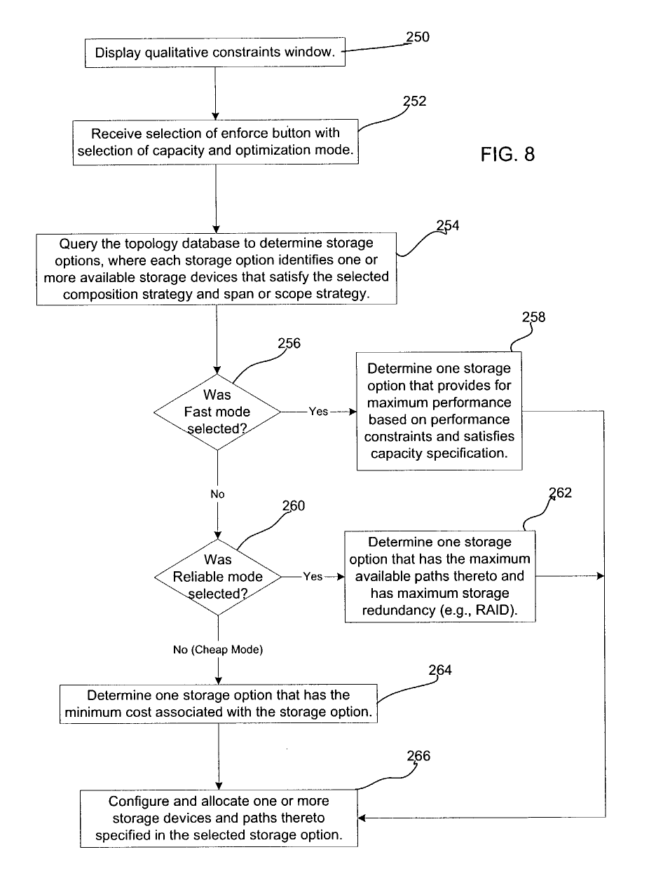

FIGS. 7 and 8 illustrate logic implemented in the configuration tool 54 to enable a user to select configuration strategies and constraints for a storage allocation in accordance with implementations of the invention. Upon receiving (at block 200) user invocation of the configuration tool 54, the configuration tool 54 renders and displays (at block 202) the strategy selection window 70 (FIG. 4) to enable the user to select a storage allocation strategy. Upon receiving (at block 204) user selection of the set strategy button 78, if (at block 206) the just-in-case strategy option in the space time trade-off strategy panel 72 (FIG. 4) was selected, then the configuration tool 54 displays (at block 208) the quantitative storage constraints window 90 (FIG. 5). Upon receiving (at block 210) selection of the evaluate button 98 in the quantitative storage constraints window 90, the configuration tool 54 queries (at block 212) the topology database 60 to determine storage options, where each storage option identifies one or more available storage devices 8, 10 (FIG. 1) that satisfies the specified constraints, such as the selected composition strategy (entered in composition strategy panel 74 (FIG. 4)) and span and scope strategy (entered in the span or scope strategy panel 76). The configuration tool 54 then determines (at block 214), for each storage option, one or more paths to each storage option that satisfies any selected alternate path constraints entered in the availability constraints panel 96 of the quantitative storage constraints window 90 (FIG. 5).

The configuration tool 54 performs a costs/benefit analysis of each determined storage option by determining (at block 216) a percentage extent to which each storage option and determined paths thereto satisfy the administrator specified performance (entered in the performance constraints panel 92 (FIG. 5)), capacity (entered in the capacity constraints panel 94) and availability constraints (entered in the availability constraints panel 96). For each storage option and determined paths thereto, a determination is made (at block 218) of a cost associated with allocating space, paths, and other resources to implement the storage option. The cost may be expressed in monetary units or some other relative cost measurement that can be analyzed by the system administrator 52. The configuration tool 54 then renders (at block 220) a selectable list of one or more of the storage options indicating the determined percentage extent to which the storage option satisfies the selected constraints and the associated cost of the option, such as the list shown in the evaluation results panel 100 (FIG. 5). Upon receiving (at block 222) system administrator 52 selection of the enforce button 102 with one of the evaluation results selected, the configuration tool 54 configures and allocates (at block 224) one or more storage devices and paths thereto specified in the selected storage option. In configuring and allocation different resources to the selected storage option, the configuration tool 54 may call one or more configuration applications 58 to perform the configuration specific operations.

If (at block 206), the just-in-time strategy was selected in the space time trade-off strategy panel 72 (FIG. 4), then control proceeds to block 250 in FIG. 8 to display the qualitative constraints window 120 (FIG. 6). Upon receiving (at block 252) user selection of the enforce button 126 with selections optionally entered in the capacity specification panel 122 and optimization mode panel 124, the configuration tool 54 queries (at block 254) the topology database 60 (FIG. 3) to determine storage options, where each determined storage option identifies one or more available storage devices that satisfy the selected composition strategy (entered in the composition strategy panel 74) and span or scope strategy (entered in the span or scope strategy panel 76). If (at block 256) the fast optimization mode was selected in the optimization mode panel 124, then a determination is made (at block 258) of one storage option that provides for maximum performance based on predefined performance constraints and satisfies any user entered capacity specification in the capacity panel 122 (FIG. 6). If (at block 258) the reliable optimization mode was selected (at block 260) then a determination is made (at block 262) of one storage option that has the maximum available paths thereto and has maximum storage redundancy (e.g., RAID). If (from the no branch of block 258) the “cheap” mode was selected, then a determination is made (at block 264) of one storage option that has the minimum cost associated with the storage option. The configuration tool 54 may have to estimate the cost of each determined storage option that could be used before selecting one storage option to allocate. The configuration tool 54 then configures and allocates (at block 266) one or more storage devices and paths thereto specified in the selected storage option, selected at block 258, 262 or 264.

With the described implementations, the configuration tool 54 enables the system administrator 52 to select an overall storage strategy comprised of component storage strategies and other selected storage constraints using a user interface. Upon the administrator selecting general strategy goals, the configuration tool 54 would then proceed to allocate and configure network and storage resources to allocate for the application and/or user needing the storage allocation. Described implementations provide a user interface tool allowing the administrator to make selections commensurate with the system administrator's knowledge and familiarity with the network storage resources, as well as the needs of the user and/or application to which the storage will be allocated. The user interface thus provides more knowledgeable administrators with greater control over configuration operations and, at the same time, would not unduly burden less knowledgeable administrators with having to make storage configuration and allocation decisions beyond their understanding.

The described techniques for enabling a user to specify configuration and allocation strategies for allocating resources may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The described implementations included specific storage strategies, such as space time trade-off, composition strategy, and span or scope strategy. In further implementations, additional or different strategies may be incorporated into the model, thereby allowing the user to specify additional strategies and configuration constraints for such strategies, which in turn would provide further control over how the configuration tool implements and allocations storage resources.

The described implementations discussed a user interface to enable a system administrator to select configuration strategies and constraints to use to configure and allocate storage. Additionally, the described implementation technique for configuring and allocating storage resources may be used by persons other than administrators, such as users, etc.

The described implementations were concerned with configuring and allocating storage resources. However, in additional implementations, the described user interface implementations may be used to enable selection of strategies and constraints to allocate resources, such as devices, components, switches, computer system, computer subcomponents (e.g., interface cards, channels, etc.), etc., other than storage resources.

FIGS. 4, 5, and 6 illustrate different arrangements of a display of selectable options for different component storage strategies, storage constraints, and qualitative constraints. The actual design of the user interface to present storage strategy selection options may differ from the arrangement shown in FIGS. 4, 5, 6. For instance, all the options may be displayed in a single window or dispersed throughout separate window as shown in FIGS. 4, 5, and 6.

The illustrated logic of FIGS. 7 and 8 shows certain events occurring in a certain order. In alternative implementations, certain of the described operations may be performed in a different order, modified or removed. Morever, steps may be added to the above described logic and still conform to the described implementations. Further, operations described herein may occur sequentially or certain operations may be processed in parallel. Yet further, operations may be performed by a single processing unit or by distributed processing units.

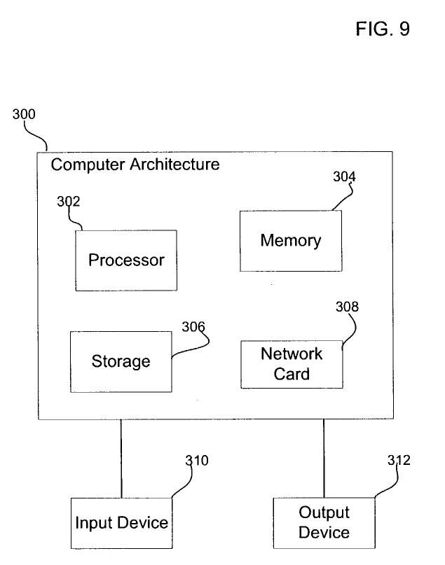

FIG. 9 illustrates one implementation of a computer architecture 300 of the components and systems shown in FIGS. 1 and 3. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computerized method for allocating resources, wherein the resources are capable of being configured from a computer system, comprising:
rendering user interface elements enabling user selection of a plurality of strategies concerning allocation of computational resources, including a participation strategy having one of at least two values indicating a degree of user involvement in the allocation of computational resources and at least one configuration strategy specifying a configuration for the resource allocation;
enabling selection of a plurality of resource allocation constraints if the selected value for the participation strategy is a first value;
enabling selection of one of a plurality of configuration modes if the selected value for the participation strategy is a second value; and
allocating the resources based on the selected at least one configuration strategy and one of the selected resource allocation constraints or the selected configuration mode.

2. The method of claim 1, wherein the selected participation strategy values include a just-in-time strategy and a just-in-case allocation strategy.

3. The method of claim 1, wherein the selected resource allocation constraints include constraints concerning performance and availability.

4. The method of claim 3, wherein the computational resource to be allocated comprise network storage resources, and wherein the selected performance constraints indicate read and write operation performance parameters for the network storage resources to allocate and wherein the availability constraints indicate path redundancy and data redundancy for the network storage resources to allocate.

5. The method of claim 1, further comprising:
determining a plurality of resource options, wherein each resource option indicates a different set of computational resources available for allocation that satisfy the selected resource allocation constraints and the selected configuration strategy; and
rendering a selectable list of the determined resource options, wherein the step of allocating computational resources performs the allocation and configuration with respect to the computational resources indicated in a selected resource option from the selectable list.

6. The method of claim 5, further comprising:
determining an extent to which each determined resource option satisfies the selected resource allocation constraints and configuration strategy; and
rendering with each resource option presented in the selectable list the determined extent for the resource option.

7. The method of claim 5, further comprising
determining a cost to allocate and configure each determined resource option; and
rendering with each resource option presented in the selectable list the determined cost for the resource option.

8. The method of claim 1, wherein the selectable configuration modes include a first configuration mode to configure the computational resources for maximum performance, a second configuration mode to configure the computational resources to maximize availability and a third configuration mode to configure the computational resources to minimize cost.

9. The method of claim 1, wherein the configuration strategies include a composition strategy having values to cause the allocation of resources configuration to perform one of: including only one instance of the resource in the allocation; including multiple instances of the resource in the allocation; and including a portion of one resource in the allocation.

10. The method of claim 1, wherein the configuration strategies include a span or scope strategy having values to cause the allocation of resources to perform one of: using homogeneous resources in the configuration or using heterogeneous resources in the configuration.

11. The method of claim 1, wherein the resources are a member of the set of resources comprising: a switch, a computer system, computer subcomponents, a storage system, and network components.

12. A system for allocating resources, comprising:
means for rendering user interface elements enabling user selection of a plurality of strategies concerning allocation of computational resources, including a participation strategy having one of at least two values indicating a degree of user involvement in the allocation of computational resources and at least one configuration strategy specifying a configuration for the resource allocation;
means for enabling selection of a plurality of resource allocation constraints if the selected value for the participation strategy is a first value;
means for enabling selection of one of a plurality of configuration modes if the selected value for the participation strategy is a second value; and
means for allocating the resources based on the selected at least one configuration strategy and one of the selected resource allocation constraints or the selected configuration mode.

13. The system of claim 12, wherein the selected participation strategy values include ajust-in-time strategy and ajust-in-case allocation strategy.

14. The system of claim 12, wherein the selected resource allocation constraints include constraints concerning performance and availability.

15. The system of claim 14, wherein the computational resource to be allocated comprise network storage resources, and wherein the selected performance constraints indicate read and write operation performance parameters for the network storage resources to allocate and wherein the availability constraints indicate path redundancy and data redundancy for the network storage resources to allocate.

16. The system of claim 12, further comprising:
means for determining a plurality of resource options, wherein each resource option indicates a different set of computational resources available for allocation that satisfy the selected resource allocation constraints and the selected configuration strategy; and
means for rendering a selectable list of the determined resource options, wherein the means for allocating computational resources performs the allocation and configuration with respect to the computational resources indicated in a selected resource option from the selectable list.

17. The system of claim 16, further comprising:
means for determining an extent to which each determined resource option satisfies the selected resource allocation constraints and configuration strategy; and
means for rendering with each resource option presented in the selectable list the determined extent for the resource option.

18. The system of claim 16, further comprising
means for determining a cost to allocate and configure each determined resource option; and
means for rendering with each resource option presented in the selectable list the determined cost for the resource option.

19. The system of claim 12, wherein the selectable configuration modes include a first configuration mode to configure the computational resources for maximum performance, a second configuration mode to configure the computational resources to maximize availability and a third configuration mode to configure the computational resources to minimize cost.

20. The system of claim 12, wherein the configuration strategies include a composition strategy having values to cause the means for allocating resources to perform one of: including only one instance of the resource in the allocation; including multiple instances of the resource in the allocation; and including a portion of one resource in the allocation.

21. The system of claim 12, wherein the configuration strategies include a span or scope strategy having values to the means for allocating resources to perform one of: using homogeneous resources in the configuration or using heterogeneous resources in the configuration.

22. The system of claim 12, wherein the resources are a member of the set of resources comprising: a switch, a computer system, computer subcomponents, a storage system, and network components.

23. An article of manufacture for allocating resources, wherein the article of manufacture is capable of causing operations to be performed, the operations comprising:
rendering user interface elements enabling user selection of a plurality of strategies concerning allocation of computational resources, including a participation strategy having one of at least two values indicating a degree of user involvement in the allocation of computational resources and at least one configuration strategy specifying a configuration for the resource allocation;
enabling selection of a plurality of resource allocation constraints if the selected value for the participation strategy is a first value;
enabling selection of one of a plurality of configuration modes if the selected value for the participation strategy is a second value; and
allocating the resources based on the selected at least one configuration strategy and one of the selected resource allocation constraints or the selected configuration mode.

24. The article of manufacture of claim 23, wherein the selected participation strategy values include a just-in-time strategy and a just-in-case allocation strategy.

25. The article of manufacture of claim 23, wherein the selected resource allocation constraints include constraints concerning performance and availability.

26. The article of manufacture of claim 25, wherein the computational resource to be allocated comprise network storage resources, and wherein the selected performance constraints indicate read and write operation performance parameters for the network storage resources to allocate and wherein the availability constraints indicate path redundancy and data redundancy for the network storage resources to allocate.

27. The article of manufacture of claim 23, further comprising:
determining a plurality of resource options, wherein each resource option indicates a different set of computational resources available for allocation that satisfy the selected resource allocation constraints and the selected configuration strategy; and
rendering a selectable list of the determined resource options, wherein the step of allocating computational resources performs the allocation and configuration with respect to the computational resources indicated in a selected resource option from the selectable list.

28. The article of manufacture of claim 27, further comprising:
determining an extent to which each determined resource option satisfies the selected resource allocation constraints and configuration strategy; and
rendering with each resource option presented in the selectable list the determined extent for the resource option.

29. The article of manufacture of claim 27, further comprising
determining a cost to allocate and configure each determined resource option; and
rendering with each resource option presented in the selectable list the determined cost for the resource option.

30. The article of manufacture of claim 23, wherein the selectable configuration modes include a first configuration mode to configure the computational resources for maximum performance, a second configuration mode to configure the computational resources to maximize availability and a third configuration mode to configure the computational resources to minimize cost.

31. The article of manufacture of claim 23, wherein the configuration strategies include a composition strategy having values to cause the allocation of resources configuration to perform one of: including only one instance of the resource in the allocation; including multiple instances of the resource in the allocation; and
including a portion of one resource in the allocation.

32. The article of manufacture of claim 23, wherein the configuration strategies include a span or scope strategy having values to cause the allocation of resources to perform one of: using homogeneous resources in the configuration or using heterogeneous resources in the configuration.
